(19) United States
(12) Patent Application Publication
(10) Pub. No.: US 2007/0242273 A1
(43) Pub. Date: Oct. 18, 2007

(54) Spectroscopic device

(75) Inventors: Thomas Bohe, Baden-Baden (DE); Dirk Fey, Neewiller pics Lcuterburg (FR)

Correspondence Address: PATENTANWAELTE LICHTI + PARTNER GBR, POSTFACH 41 07 60, D-76207, KARLSRUHE, omitted

(73) Assignee: Gunther Krieg, Karlsruhe (DE)

(21) Appl. No.: 11/783,756

(22) Filed: Apr. 12, 2007

(30) Foreign Application Priority Data
Apr. 15, 2006 (DE) DE 102006017702.9

(51) Int. Cl. G01N 21/61; G01N 21/01

(52) U.S. Cl. 356/437; 356/440

(57) ABSTRACT

The invention proposes a spectroscopic device and a spectroscopic method, comprising a tubular measuring cell, in particular, for absorption spectroscopy of contaminated carbon dioxide, wherein the measuring cell is stabilized using at least one tube which is disposed parallel to the direction of extension of the measuring cell and is rigidly connected to the measuring cell.

The application claims Paris Convention priority of DE 10 2006 017 702.9 filed Apr. 15, 2006 the complete disclosure of which is hereby incorporated by reference.

### BACKGROUND OF THE INVENTION

The invention concerns a spectroscopic device and method, in particular for the analysis of chemically contaminated carbon dioxide, using a tubular measuring cell.

Absorption spectroscopy is an important tool of trace analysis, i.e. the determination of small to smallest amounts of a substance in the presence of large amounts of main components, and is important mainly in chemical industry, metallurgy, medicine, biology, geology and criminology. A method of this type is characterized by the analysis of an absorption spectrum which is obtained from irradiation of a contaminated gaseous substance through an emission spectrum of known power density and provides information about the exact amounts of the composition of the investigated substance mixture. The contamination of chemically produced carbon dioxide may e.g. be monitored, which is used as a by-product, in particular, in the Haber-Bosch method for producing fertilizer, from refinery exhaust gases or combustion machines (the latter, in particular, in developing countries) e.g. for the production of beverages containing carbonic acid. Benzene has a characteristic line spectrum with five lines having a fine structure in the range between 230 nm and 270 nm. Since benzene is carcinogenic, it must not exceed a limit value of 20 ppb, and methane (which is not carcinogenic) must not exceed a limit value of 1 ppm. In order to provide reliable monitoring, benzene must be detectable with a precision of 3 ppb. Benzene in this region produces a logarithmic weakening of the intensity on an order of magnitude of 10⁻⁵ even with a quite large transmission length through carbon dioxide of a magnitude of approximately 2 m.

Detection of these small gas amounts with the required measuring accuracy inevitably requires highly sensitive measuring devices, which involves great expense and a complex and therefore immobile structure of the measuring device. At the same time, optimization of the measuring signal and elimination of measurement-impairing effects must meet high demands, which depend, in particular, on the respective measuring environment, such that, despite the small absorption coefficient, such a small amount of substance can be detected with a signal strength above the background noise. Departing from the natural line width which inevitably results from the average excitation time of a basic molecular state from the Heisenberg uncertainty relation, in particular Doppler and pressure broadening mechanisms contribute to a reduced absorption coefficient, which can again be influenced by parameters of the measuring environment. Moreover, a sufficiently high radiation density, a sufficiently long transmission path and collection of a maximum size component of the irradiated wave spectrum yield a signal strength above the noise limit.

It is therefore the underlying purpose of the invention to further develop a method of the above-mentioned type in such a manner that it has a high reproducibility of the measuring results, minimum expense and simple applicability in addition to the above-mentioned complex requirements.

### SUMMARY OF THE INVENTION

This object is achieved in accordance with the invention with a device of the above-mentioned type in that the measuring cell is rigidly connected to at least one tube which is disposed parallel to the direction of extension of the measuring cell. In a method of this type, the measuring cell is stabilized by a rigid connection with at least one tube which is disposed parallel to the direction of extension of the measuring cell.

The measuring cell has a stable tube with massive walls. The tube has closed end faces. The wall is also completely closed except for the gas inlet and outlet. The overall optical configuration is disposed in the closed tube; light irradiation, reflection optics, and receiver. The light can be irradiated into the tube and be extracted from the tube via light guides.

The measuring cell is thereby stabilized in a simple and constructive fashion, at the same time spatially expanding the overall stabilized measuring device. The present invention is based on the idea of damping the oscillations induced by ambient influences, and on a strong decay behavior thereof due to increased inertia of the resonance body. This also reduces the excitation energy of molecular motion of the gas to be investigated, thereby reducing the pressure broadening, increasing the absorption coefficient, suppressing the noise of the measuring spectrum and also increasing the measuring accuracy. This reduction of disturbing influences on the measuring process is of essential importance, in particular, for measurements close to the noise limit, e.g. for determining the benzene content in contaminated carbon dioxide.

In accordance with an extremely preferred further development of the inventive device, the measuring cell is stabilized to a particularly large degree in that each end of the measuring cell is rigidly connected to at least one tube which is disposed parallel to the direction of extension of the measuring cell. For the same purpose, the tubes disposed on both sides parallel to the measuring cell may be rigidly connected. In particular, the measuring cell may be further rigidly connected in the peripheral direction to one tube disposed parallel to the direction of extension of the measuring cell.

In a preferred embodiment, the tube(s) disposed parallel to the measuring cell is/are formed from a material having a heat expansion coefficient which is smaller or equal to that of glass. This ensures that the rigid connection and therefore the stabilization of the measuring cell is maintained even when the ambient temperature fluctuates and, in particular, when the temperature of the gas mixture to be analysed varies. This facilitates handling of the spectroscopic device for measurements with different sample temperatures, which can be adjusted to a suitably low value, in particular, to reduce pressure broadening and suppress noise. Chemically contaminated carbon dioxide can e.g. be fed into the measuring cell to perform the inventive spectroscopic method, and its temperature can be varied. In particular, in benzene spectroscopy, temperature-dependent measurements may be advantageous, since benzene molecules only form van der Waals complexes among each other, which are extremely unstable far below room temperature. Temperature changes therefore have no great influence on the measuring spectrum but can increase the measuring accuracy. The measuring cell moreover has a thermostat to monitor the temperature.

In a particularly preferred embodiment, the tube(s) disposed parallel to the measuring cell are formed from the same material as the measuring cell, in particular, of glass. This provides particularly simple and inexpensive production of individual stabilized spectroscopic devices in accordance with the invention, since readily available measuring cells can be used as tubes for stabilizing the actual measuring cell. In a further development, tubes which are provided for stabilization can also be used as measuring cells, e.g. for spectroscopy of a comparative gas. In a further preferred embodiment, the tube(s) disposed parallel to the measuring cell has/have the same length and/or the same diameter as the measuring cell. Moreover, the measuring cell has a length of between 50 and 150 cm, in particular in a region of 100 cm, and a diameter of between 1 and 5 cm, in particular in a region of 3 cm. This provides an optimum compromise between transmission length required for measuring accuracy and compact measurement structure, in particular, for determining a benzene content on the order of magnitude of 3 ppb.

In accordance with another preferred further development, the rigid connection is formed using one or more rigid connecting member(s) disposed on the surface of the tube(s) and the surface of the measuring cell. The connection may therefore be designed very freely, in particular, almost any number of connecting elements may be arranged. For the above-mentioned reasons, the rigid connecting member is thereby formed from a material having a thermal expansion coefficient which is less than or equal to that of glass. The rigid connection is preferably additionally or exclusively formed by one or two rigid connecting member(s) disposed on each end side of the measuring cell and the tube(s). This provides a compact measuring device construction in addition to (additional) stabilization of the measuring cell, since such a rigid connecting member disposed on the end sides of the measuring cell may contain means for guiding a measuring beam through the measuring cell, which yields additional great stabilization of this measuring beam. This is advantageous, in particular, when the measuring surroundings often change, or for measurements in surroundings that cause maladjustment of the measuring beam, e.g. in the surroundings of industrial production plants, such that tiresome and time-consuming readjustment and optimization of the optical path can be avoided and the spectroscopic device can be easily used after one single alignment of the measuring beam, even by an operator who has little experience in the optical field. Towards this end, an end side connecting member has at least one parabolic mirror for feeding and aligning a beam from a light source into the measuring cell. The other end-side connecting member preferably has a mirror for reflecting the fed light beam, such that the measuring beam passes twice through the measuring cell, and a maximum transmission path with maximum compact construction is obtained. Moreover, the end-side connecting member with parabolic mirror for feeding a light beam has a further parabolic mirror for extracting the light beam reflected from the other end-side connection, the extracted light beam being fed to a detector and/or spectrometer. The light beam may thereby be coupled from a light guide, such as e.g. a glass-fiber cable, into the measuring cell and/or removed from the measuring cell into a light guide. Coupling into or removal from the light guides is thereby effected by the parabolic mirrors disposed in an end-side connecting member. Optical lenses may alternatively be used.

In particular, when the inventive spectroscopic device is used to determine the benzene content in chemically contaminated carbon dioxide, a Xenon light source that emits light in the UV range, in particular, in a wavelength range of between 220 nm and 280 nm, may be provided as a light source, and a silicon array may be provided as a detector/spectrometer. Alternatively, a light source that emits light in the infrared range may be used as a light source, and an HgCdTe array may be provided as a detector/spectrometer. The received signal is spatially spectrally analyzed by a prism or preferably a grid. A high-resolution detector array with a measuring resolution of up to 1024 pixels can be used. In particular, in this case, the required grid constant of the spectrometer is sufficiently high, that the intensity incident on a pixel is considerably reduced compared to the input signal. Towards this end, a further development of the inventive device provides reduction of noise through a lock-in technology, wherein the extracted light beam is detected by a lock-in amplifier. The spectrum measured through superposition of several spectra can be evaluated through spectral deconvolution into the individual spectra using the PLS algorithm, wherein the individual spectral peaks or spectral shapes are separated from each other and/or from background noise.

In general, (tunable) laser sources and also spontaneously emitting light sources may be used, such as Xenon gas discharge lamps or deuterium lamps. The latter have a natural broad emission spectrum, but lower power density which may be insufficient for an investigation of smallest substance amounts with small absorption coefficients. Conversely, a (tunable) laser source with a high power density has a limited wavelength range whose excitation energy is available to analyse the gas. Alternatively, super-luminescent light sources may also be used, which constitute a compromise between the broad-band conventional beams and laser emission sources in view of spectral bandwidth and power density. When a laser source is used, at least sections of the measuring cell may preferably form a laser cavity. A conventional laser can e.g. have an extremely low reflection coefficient on the side facing the measuring cell, e.g. have an anti-reflection coating, such that the mirror limiting the laser cavity is formed by a mirror integrated in the end-side connecting member of the measuring cell. This configuration can substantially improve the measuring accuracy when the laser is operated in the region of the threshold value, since it is highly sensitive to loss induced by absorption in this region.

Clearly, the inventive spectroscopic device can also be used for other applications than absorption spectroscopy and trace analysis. The advantages of the invention can also be utilized in fluorescence spectroscopy.

Further properties and advantages of the invention can be extracted from the following description of an embodiment with reference to the enclosed drawing, and from the claims.

### BRIEF DESCRIPTION OF THE DRAWING

FIG. 1 shows a schematic view of an inventive spectroscopic device, in particular, for trace analysis of contaminated carbon dioxide.

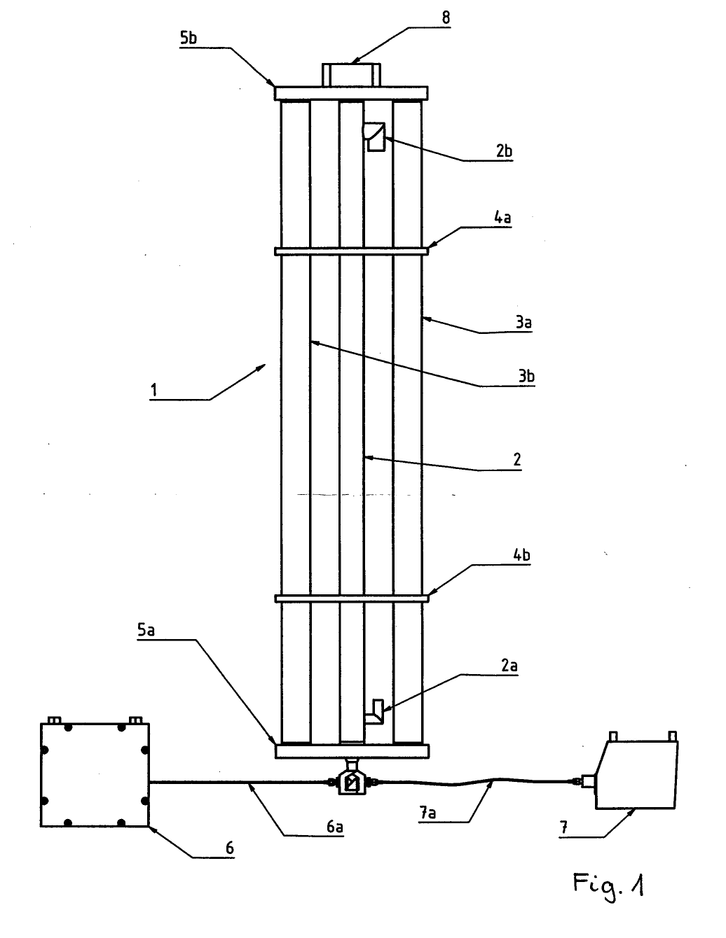

### DESCRIPTION OF THE PREFERRED EMBODIMENT

The inventive spectroscopic device 1 for trace analysis of contaminated carbon dioxide has a measuring cell 2 with a tube 2.1 which surrounds the measuring optics and is closed at the end faces. The tube 2.1 has two gas inlet connecting pieces 2a and 2b via which the measuring cell 2 can be evacuated or filled with a gas for trace analysis, such as e.g. contaminated carbon dioxide. In order to mechanically stabilize the measuring cell 2, the measuring cell in accordance with the invention is rigidly connected to the tubes 3a and 3b using connecting elements 4a and 4b which completely surround the tube periphery and are fixed in the peripheral direction.

In accordance with the invention, the connecting elements 5a and 5b, whose end sides are fixed to the measuring cell 2 and the tubes 3a and 3b, respectively, further enhance stabilization of the measuring cell 2. These have means which can be adjusted and rigidly fixed in accordance with the invention for coupling and removing a measuring beam into or out of the measuring cell 2, to stabilize the measuring beam, and further increase the measuring accuracy, while resulting in a measuring device of maximum compact structure. A first parabolic mirror is integrated in the connecting element 5a disposed on the front side, for feeding and aligning the light beam coupled from the light source 6 into the light guide 6a. Moreover, the connecting element 5b which is disposed at the rear side has a mirror for reflecting the measuring beam, which can be adjusted via adjusting screws 8 such that, in accordance with the invention, the measuring beam passes the measuring cell twice, to double the effective absorption rate compared to single passage of the measuring beam, thereby further increasing the measuring accuracy with maximum compact device size. A second parabolic mirror which is integrated in the connecting element 5a effectively extracts the measuring beam into a light guide 7a. The rear side mirror can be adjusted via the adjusting screws, such that the light beam fed using the first parabolic mirror is reflected by the mirror on the rear side connecting element 5b to the second parabolic mirror and thus into the light guide 7a. This is followed by measurement and evaluation of the absorption spectrum of the decoupled measuring beam in a detector/spectrometer 7 provided for this purpose.

Divergent or convergent lenses (not shown) may moreover be provided for coupling and extracting the light beams into and out of the light guides.

We claim:

1. A spectroscopic device comprising:
a tubular measuring cell;
at least one tube disposed parallel to a direction of extension of said measuring cell; and
means for rigidly connecting said measuring cell to said tube.

2. The spectroscopic device of claim 1, wherein said measuring cell is rigidly connected on both sides to at least one tube disposed parallel to a direction of extension of said measuring cell.

3. The spectroscopic device of claim 2, wherein tubes are disposed on both sides parallel to said measuring cell and are rigidly connected to each other.

4. The spectroscopic device of claim 1, wherein said at least one tube is formed from a material having a thermal expansion coefficient which is smaller than or equal to that of glass.

5. The spectroscopic device of claim 4, wherein said at least one tube is formed from a same material as said measuring cell.

6. The spectroscopic device of claim 4, wherein said at least one tube is made from glass.

7. The spectroscopic device of claim 1, wherein said connecting means comprises one or more rigid connecting elements disposed on a surface of said at least one tube and on a surface of said measuring cell.

8. The spectroscopic device of claim 1, wherein said connecting means comprises one or two rigid connecting elements disposed on each end of said measuring cell and said at least one tube.

9. The spectroscopic device of claim 7, wherein each of said rigid connecting elements is made from of a material having a heat expansion coefficient which is smaller than or equal to that of glass.

10. The spectroscopic device of claim 8, further comprising a light source, wherein a first end-side connecting element has at least one parabolic mirror for feeding and aligning a light beam from said light source into said measuring cell.

11. The spectroscopic device of claim 10, wherein a second end-side connecting element comprises a mirror for reflecting said light beam in said measuring cell.

12. The spectroscopic device of claim 11, wherein said first end-side connecting element has a further parabolic mirror for decoupling said light beam reflected on said second element.

13. The spectroscopic device of claim 12, further comprising a detector and/or spectrometer to which a decoupled light beam is fed.

14. The spectroscopic device of claim 13, wherein said light source is a light source that radiates in a UV range and said detector or spectrometer comprises a silicon array.

15. The spectroscopic device of claim 13, wherein said light source is a light source that emits light in an infrared range and said detector or spectrometer comprises a HgCdTe array.

16. The spectroscopic device of claim 1, wherein said at least one tube has a same length as said measuring cell.

17. The spectroscopic device of claim 1, wherein said at least one tube has a same diameter as said measuring.

18. The spectroscopic device of claim 1, wherein said measuring cell has a length of between 50 and 150 cm or in a region of 100 cm.

19. The spectroscopic device of claim 1, wherein said measuring cell has a diameter of between 1 and 5 cm or in a region of 3 cm.

20. The spectroscopic device of claim 13, wherein said decoupled light beam is detected by a lock-in amplifier.

21. The spectroscopic device of claim 1, wherein said light beam is coupled from a light guide into said measuring cell and/or is decoupled from said measuring cell into a light guide.

22. The spectroscopic device of claim 1, wherein said measuring cell comprises a thermostat.

23. The spectroscopic device of claim 1, wherein chemically contaminated carbon dioxide is fed into said measuring cell.

24. The spectroscopic device of claim 1, wherein said measuring cell comprises one or more measuring tubes.

25. The spectroscopic device of claim 1, wherein, in a peripheral direction, said measuring cell has at least one further rigid connection to a respective said at least one tube.

26. The spectroscopic device of claim 10, wherein said light source comprises a laser.

27. The spectroscopic device of claim 10, wherein at least portions of said measuring cell define a laser cavity.

28. The spectroscopic device of claim 10, wherein said light source is a spontaneous emission source.

29. A spectroscopic method using the device of claim 1.
